(19) United States
(12) Patent Application Publication
(10) Pub. No.: US 2006/0082559 A1
(43) Pub. Date: Apr. 20, 2006

(54) Display device

(75) Inventors: Hendrik Klaas Louwsma, HEERLEN (NL); Alexander Johan Rosa Trags, Heerlen (NL); Martinus Petrus Creusen, Heerlen (NL); Pavel Novoselov, Heerlen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/535,369

(22) PCT Filed: Oct. 28, 2003
(86) PCT No.: PCT/IB03/04829

§ 371 Date: May 18, 2005

(30) Foreign Application Priority Data
Nov. 21, 2002 (EP) 02079852.6

(51) Int. Cl. G09G 5/00

(52) U.S. Cl. 345/204

(57) ABSTRACT

In RMS driving (both Alt & Pleshko and MRA addressing) of passive matrix devices flicker and power are reduced by driving groups of picture elements during time periods within a sequence of time periods while the driving of different picture elements within a sequence of time periods is phase-shifted over at least one time period, while the phase shifting is altered after each sequence of time periods. The principle of phase-shifting is also applicable to active matrix driving.

The invention relates to a display device comprising a liquid crystal material between a first substrate provided with row or selection electrodes and a second substrate provided with column or data electrodes, in which overlapping parts of the row and column electrodes define picture elements, drive means for driving the column electrodes in conformity with an image to be displayed, and drive means for driving the row electrodes.

Such display devices are used in, for example, portable apparatuses such as laptop computers, notebook computers and telephones.

Passive-matrix displays of this type are generally known and are generally driven by providing the row or selection electrodes with selecting voltages and simultaneously supplying data voltages to the column or data electrodes as described by Alt & Pleshko in IEEE Trans El. Dev. Vol. ED-21, No. 2, February 1974, pp 146-155. For realizing a high number of lines, passive-matrix displays are increasingly based on the STN (Super-Twisted Nematic) effect. An article by T. J. Scheffer and B. Clifton “Active Addressing Method for High-Contrast Video Rate STN Displays”, SID Digest 92, pp. 228-231 describes how the phenomenon of “frame response” which occurs with rapidly switching liquid crystal materials is avoided by making use of “Active Addressing”. In this method, all rows are driven throughout the frame period with mutually orthogonal signals, for example, Walsh functions. The result is that each picture element is continuously excited by pulses (in an STN LCD of 240 rows: 256 times per frame period) instead of once per frame period. In “multiple row addressing” or MRA, a (sub-) group of p rows is driven with mutually orthogonal signals.

Display cells based on the STN (Super-Twisted Nematic) effect generally have a very steep transmission voltage characteristic, which makes it difficult to realize gray levels. One method is sub-pixellation which goes at the cost of the maximum number of lines. Another method is “frame rate control” (FRC) which is a technique to generate different gray values by varying the state of a picture element between ON and OFF within a certain number of consecutive frame periods.

In this respect a frame period is the period in which all rows are selected one time, be it separately (Alt & Pleshko) or in groups (MRA). Thanks to the persistency of the human vision system and the properties of the liquid crystal, the different states are averaged and perceived as one gray value.

If the number of gray levels within a grayscale increases however the number of consecutive frame periods (which is also called a super-frame in this patent application) increases too, leading to flicker.

It is, inter alia, an object of the invention to provide a display device of the type described above, in which flicker is minimized.

A further purpose of the invention is to provide a display device of the type described above, in which the power used is lowered as compared to existing devices.

To this end, a device according to the invention has drive means comprising means for driving a group of picture elements during time periods within a sequence of time periods, the driving of different picture elements within a sequence of time periods being phase-shifted with respect to each other

A phase in this patent application is understood to be the number of a sub-selection period in a sequence of time periods, when considering the total number of sequences, in this case the number of the position of the phase in a super-frame. In fact it specifies the (sub)-selection period at which a picture element or a group of picture elements is selected. Similar remarks apply to selecting a picture element or a group of picture elements during selection of a sub-selection time in subsequent sequences of selection times.

The invention is based inter alia on the insight that non-sequential selections of time periods within a sequence of time periods leads to different periodical driving (or even non-periodical driving) of different picture elements. The human vision system more easily averages different states now, which are perceived as one gray value.

The phase shifting may be altered after each sequence of time periods.

On the other hand the invention is based on the insight that by using a special grayscale table the number of voltage transitions in a driver may be diminished.

A special embodiment of the invention therefore comprises a grayscale table for generating graylevel data in which grayscale table sequences of s (s>1) sequential graylevels are defined by grouping s sequential graylevels within a sequence, said sequences being allotted to non-sequential selections of time periods within a sequence of time periods.

In this case preferably (s-1) increases (or decreases) of the number of selections within a sequence of selections are allotted to one time period only. Said time period may comply with a frame period in which a sequence of time periods is a sequence of frame periods.

A preferred embodiment of a device according to the invention in this case comprises means to change the frame-phase of a frame during selection of said frame in subsequent sequences of frame periods.

The principle of phase shifting may also be applied to the driving of active matrix LCDs in which switching means for connecting the picture electrodes to the selection electrodes and data electrodes are provided on a first substrate. In such AMLCD applications gray-values are generated by generating analogue voltages e.g. via a resistor chain. The analogue voltages are then buffered (e.g. one buffer per gray-value) in an output buffer. If one needs 6 bit per color, that is 64 gray-values per color (256 for 8 bit) 64 buffers (256 for 8 bit) are needed. Using the principle of the invention grey-values can be generated by using time averaging between two gray-values, e.g. 4 (or 8). As a consequence, the number of generated voltages via the resistor chain can be reduced and hence also the number of buffers in the output stage. As a result, the output stage becomes smaller which reduces the driver cost whereas having less number of buffers reduces the power consumption of the display driver.

These and other aspects of the invention will now be elucidated with reference to an embodiment and the drawings in which

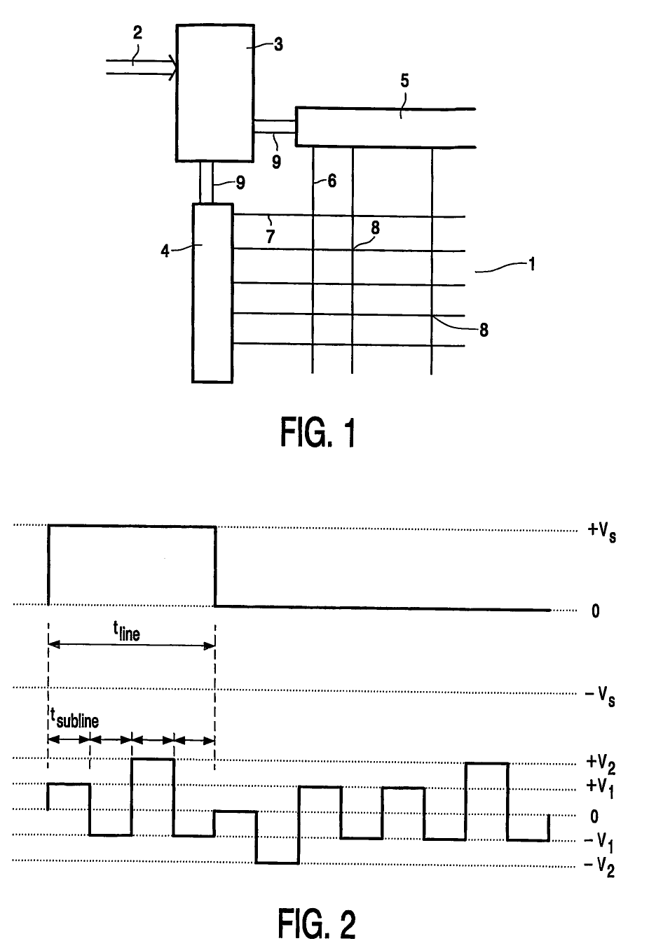

FIG. 1 shows an electric equivalent circuit diagram of a part of a display device in which the invention is used,

FIG. 2 shows selection and data voltages for a display device according to FIG. 1,

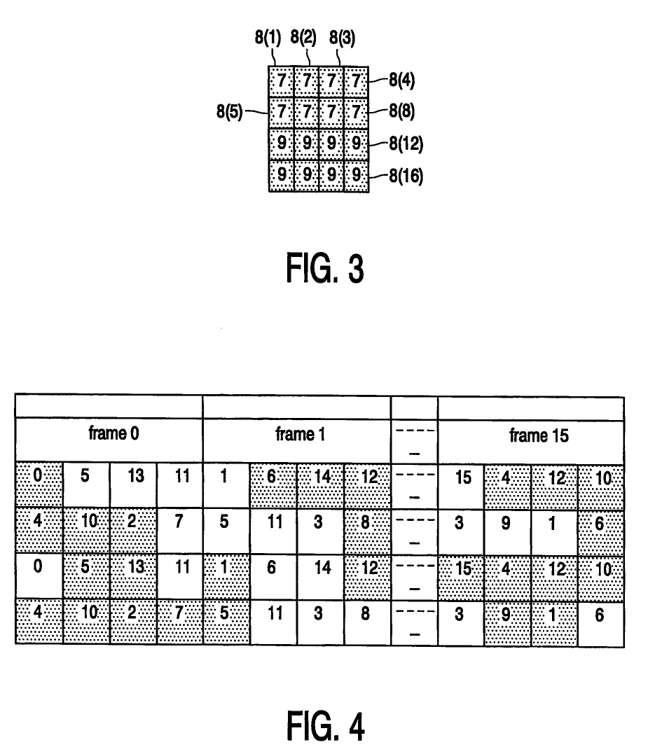

FIG. 3 shows a set of picture elements having certain gray-levels

FIG. 4 schematically shows one way of driving these picture elements to display said gray-levels, while

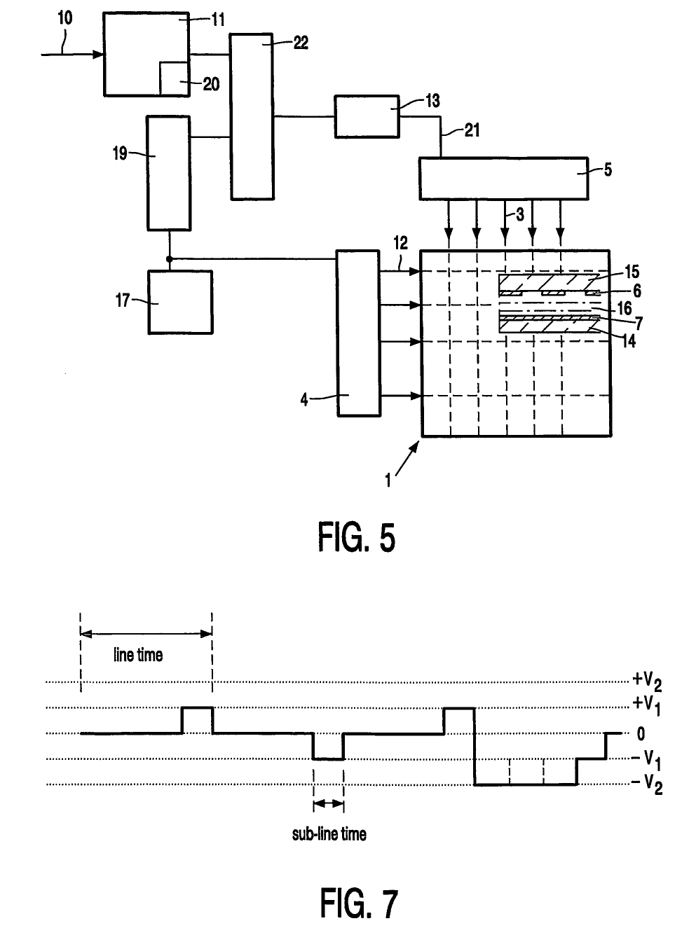

FIG. 5 shows an electric equivalent circuit diagram of a part of another display device in which the invention is used, and

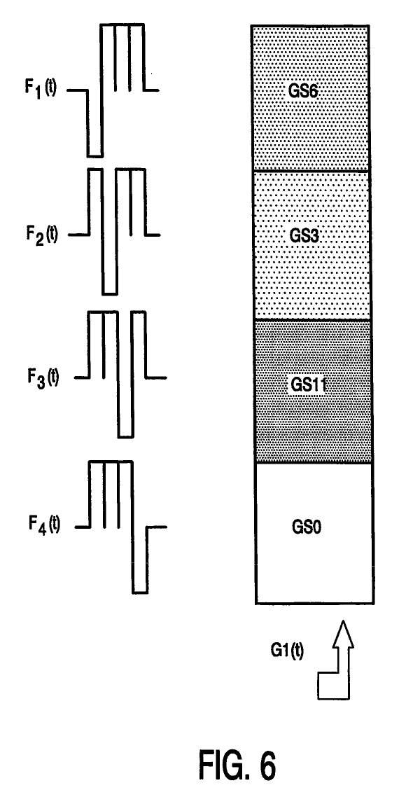

FIGS. 6 and 7 show selection and data voltages for a display device according to FIG. 5.

The Figures are diagrammatic and not drawn to scale. Corresponding elements are generally denoted by the same reference numerals.

FIG. 1 is an electric equivalent circuit diagram of a part of a display device 1 to which the invention is applicable. It comprises a matrix of picture elements 8 defined by the areas of crossings of m row or selection electrodes 7 and n column or data electrodes 6. The row electrodes, in one mode of driving, are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

A first method to drive the display device 1 by selecting all rows sequentially (or non-sequentially) by selecting one line at a time (Alt & Pleshko addressing). The period over which all lines are selected is called a frame (time). Using multiple frames it is possible to generate gray-levels. The number of frames in which a grayscale is defined is indicated as a superframe. Table 1 shows a superframe consisting of 4 frames in which 5 gray-levels can be generated.

TABLE 1

| gray-level | frame 1 | frame 2 | frame 3 | frame 4 |
|---|---|---|---|---|
| GS 0 | off | off | off | off |
| GS 1 | on | off | off | off |
| GS 2 | on | off | on | off |
| GS 3 | on | on | on | off |
| GS 4 | on | on | on | on |

In fact Table 1 defines a grayscale table for generating graylevel data in which gray scale table sequences of s (s=5) sequential gray levels are defined by grouping the gray levels within the sequence of time periods (a superframe) as shown (and with 16 frames basically 17 gray values could be generated). If such gray levels are kept constant for a certain longer time period, different picture elements are driven by a driver which repeats these superframes, as shown in Table 2

TABLE 2

| gray- | fr 1 | fr 2 | fr 3 | fr 4 | fr 1 | fr 2 | fr 3 | fr 4 | fr 1 | fr 2 | fr 3 | fr 4 |
|---|---|---|---|---|---|---|---|---|---|---|---|---|
| level | Superframe 1 | | | | Superframe 2 | | | | Superframe 3 | | | |
| GS 0 | off | off | off | off | off | off | off | off | off | off | off | off |
| GS 1 | on | off | off | off | on | off | off | off | on | off | off | off |
| GS 2 | on | off | on | off | on | off | on | off | on | off | on | off |
| GS 3 | on | on | on | off | on | on | on | off | on | on | on | off |
| GS 4 | on | on | on | on | on | on | on | on | on | on | on | on |

To obtain GS 3 in e.g. four picture elements (pixels) the driving would be:

TABLE 2′

| | fr 1 | fr 2 | fr 3 | fr 4 | fr 1 | fr 2 | fr 3 | fr 4 | fr 1 | fr 2 | fr 3 | fr 4 |
|---|---|---|---|---|---|---|---|---|---|---|---|---|
| | Superframe 1 | | | | Superframe 2 | | | | Superframe 3 | | | |
| pixel 0 | on | on | on | off | on | on | on | off | on | on | on | off |
| pixel 1 | on | on | on | off | on | on | on | off | on | on | on | off |
| pixel 2 | on | on | on | off | on | on | on | off | on | on | on | off |
| pixel 3 | on | on | on | off | on | on | on | off | on | on | on | off |

Since for all gray values the same superframes are time-sequentially repeated, this leads to noticeable flickering. To avoid this, according to the invention a mixing technique is used. For example, to obtain GS 3, instead of switching off the picture element during the last out of the four consecutive frames as depicted in Table 2, different (neighbouring) picture elements (pixels) are switched off in the fourth, first and second frame for the different picture elements respectively (Table 3). In total, there exist four different patterns to generate GS 3 with four frames in one superframe resulting in:

TABLE 3

| | fr 1 | fr 2 | fr 3 | fr 4 | fr 1 | fr 2 | fr 3 | fr 4 | fr 1 | fr 2 | fr 3 | fr 4 |
|---|---|---|---|---|---|---|---|---|---|---|---|---|
| gray-level 3 | Superframe 1 | | | | Superframe 2 | | | | Superframe 3 | | | |
| pixel 0 | on | on | on | off | on | on | on | off | on | on | on | off |
| pixel 1 | on | on | off | on | off | on | off | on | on | on | off | on |
| pixel 2 | on | off | on | on | on | off | on | on | on | off | on | on |
| pixel 3 | off | on | on | on | off | on | on | on | off | on | on | on |

So in this example time periods comply with a frame period in which a sequence of time periods is a sequence of frame periods within a sequence of time periods (within a superframe). According to the invention, the driving of different picture elements within a sequence of time periods (a superframe) is phase-shifted over one frame period time period relative to each other for different pixels (a phase in this example corresponding to a frame). The phase shifting may be altered after each sequence of time periods (superframe).

Another way to generate gray levels is to split the line time for the column signal. FIG. 2 shows a line time split into 4 parts (indicated as sub-line times), which also results in 5 gray levels, while a phase in this example corresponds to a sub-line time. Combining the principle of line time splitting with the principle as described with respect to Tables 1, 2, opens the possibility of generating 17 gray-levels (GS0-GS16), as shown in Table 4

TABLE 4

| | frame | | | | | | | | | | | | | | | |
|---|---|---|---|---|---|---|---|---|---|---|---|---|---|---|---|---|
| | Frame 0 | | | | Frame 1 | | | | Frame 2 | | | | Frame 3 | | | |
| | pulse | | | | | | | | | | | | | | | |
| | P0 | P1 | P2 | P3 | P0 | P1 | P2 | P3 | P0 | P1 | P2 | P3 | P0 | P1 | P2 | P3 |
| GS0 | 0 | 0 | 0 | 0 | 0 | 0 | 0 | 0 | 0 | 0 | 0 | 0 | 0 | 0 | 0 | 0 |
| GS1 | 1 | 0 | 0 | 0 | 0 | 0 | 0 | 0 | 0 | 0 | 0 | 0 | 0 | 0 | 0 | 0 |
| GS2 | 1 | 1 | 0 | 0 | 0 | 0 | 0 | 0 | 0 | 0 | 0 | 0 | 0 | 0 | 0 | 0 |
| GS3 | 1 | 1 | 1 | 0 | 0 | 0 | 0 | 0 | 0 | 0 | 0 | 0 | 0 | 0 | 0 | 0 |
| GS4 | 1 | 1 | 1 | 1 | 0 | 0 | 0 | 0 | 0 | 0 | 0 | 0 | 0 | 0 | 0 | 0 |
| GS5 | 1 | 1 | 1 | 1 | 1 | 0 | 0 | 0 | 0 | 0 | 0 | 0 | 0 | 0 | 0 | 0 |
| GS6 | 1 | 1 | 1 | 1 | 1 | 1 | 0 | 0 | 0 | 0 | 0 | 0 | 0 | 0 | 0 | 0 |
| GS7 | 1 | 1 | 1 | 1 | 1 | 1 | 1 | 0 | 0 | 0 | 0 | 0 | 0 | 0 | 0 | 0 |
| GS8 | 1 | 1 | 1 | 1 | 1 | 1 | 1 | 1 | 0 | 0 | 0 | 0 | 0 | 0 | 0 | 0 |
| GS9 | 1 | 1 | 1 | 1 | 1 | 1 | 1 | 1 | 1 | 0 | 0 | 0 | 0 | 0 | 0 | 0 |
| GS10 | 1 | 1 | 1 | 1 | 1 | 1 | 1 | 1 | 1 | 1 | 0 | 0 | 0 | 0 | 0 | 0 |
| GS11 | 1 | 1 | 1 | 1 | 1 | 1 | 1 | 1 | 1 | 1 | 1 | 0 | 0 | 0 | 0 | 0 |
| GS12 | 1 | 1 | 1 | 1 | 1 | 1 | 1 | 1 | 1 | 1 | 1 | 1 | 0 | 0 | 0 | 0 |
| GS13 | 1 | 1 | 1 | 1 | 1 | 1 | 1 | 1 | 1 | 1 | 1 | 1 | 1 | 0 | 0 | 0 |
| GS14 | 1 | 1 | 1 | 1 | 1 | 1 | 1 | 1 | 1 | 1 | 1 | 1 | 1 | 1 | 0 | 0 |
| GS15 | 1 | 1 | 1 | 1 | 1 | 1 | 1 | 1 | 1 | 1 | 1 | 1 | 1 | 1 | 1 | 0 |
| GS16 | 1 | 1 | 1 | 1 | 1 | 1 | 1 | 1 | 1 | 1 | 1 | 1 | 1 | 1 | 1 | 1 |

The driving of different picture elements within a sequence of time periods according to the invention is phase-shifted over one frame period time period within two sequential superframes again (a phase now corresponding to a sub-line time). According to the invention the phase shifting is altered after each sequence of time periods (superframe), which implies for example the following driving in the next superframe (Table 5)

TABLE 5

| | frame | | | | | | | | | | | | | | | |
|---|---|---|---|---|---|---|---|---|---|---|---|---|---|---|---|---|
| | Frame 0 | | | | Frame 1 | | | | Frame 2 | | | | Frame 3 | | | |
| | pulse | | | | | | | | | | | | | | | |
| | P0₀₀ | P1₀₀ | P2₀₀ | P3₀₀ | P1₀₁ | P2₀₁ | P3₀₁ | P0₀₁ | P2₀₂ | P3₀₂ | P0₀₂ | P1₀₂ | P3₀₃ | P0₀₃ | P1₀₃ | P2₀₃ |
| GS0 | 0 | 0 | 0 | 0 | 0 | 0 | 0 | 0 | 0 | 0 | 0 | 0 | 0 | 0 | 0 | 0 |
| GS1 | 1 | 0 | 0 | 0 | 0 | 0 | 0 | 0 | 0 | 0 | 0 | 0 | 0 | 0 | 0 | 0 |
| GS2 | 1 | 1 | 0 | 0 | 0 | 0 | 0 | 0 | 0 | 0 | 0 | 0 | 0 | 0 | 0 | 0 |
| GS3 | 1 | 1 | 1 | 0 | 0 | 0 | 0 | 0 | 0 | 0 | 0 | 0 | 0 | 0 | 0 | 0 |
| GS4 | 1 | 1 | 1 | 1 | 0 | 0 | 0 | 0 | 0 | 0 | 0 | 0 | 0 | 0 | 0 | 0 |
| GS5 | 1 | 1 | 1 | 1 | 0 | 0 | 0 | 1 | 0 | 0 | 0 | 0 | 0 | 0 | 0 | 0 |
| GS6 | 1 | 1 | 1 | 1 | 1 | 0 | 0 | 1 | 0 | 0 | 0 | 0 | 0 | 0 | 0 | 0 |
| GS7 | 1 | 1 | 1 | 1 | 1 | 1 | 0 | 1 | 0 | 0 | 0 | 0 | 0 | 0 | 0 | 0 |
| GS8 | 1 | 1 | 1 | 1 | 1 | 1 | 1 | 1 | 0 | 0 | 0 | 0 | 0 | 0 | 0 | 0 |
| GS9 | 1 | 1 | 1 | 1 | 1 | 1 | 1 | 1 | 0 | 0 | 0 | 1 | 0 | 0 | 0 | 0 |
| GS10 | 1 | 1 | 1 | 1 | 1 | 1 | 1 | 1 | 0 | 0 | 1 | 1 | 0 | 0 | 0 | 0 |
| GS11 | 1 | 1 | 1 | 1 | 1 | 1 | 1 | 1 | 1 | 0 | 1 | 1 | 0 | 0 | 0 | 0 |
| GS12 | 1 | 1 | 1 | 1 | 1 | 1 | 1 | 1 | 1 | 1 | 1 | 1 | 0 | 0 | 0 | 0 |
| GS13 | 1 | 1 | 1 | 1 | 1 | 1 | 1 | 1 | 1 | 1 | 1 | 1 | 0 | 1 | 0 | 0 |
| GS14 | 1 | 1 | 1 | 1 | 1 | 1 | 1 | 1 | 1 | 1 | 1 | 1 | 0 | 1 | 1 | 0 |
| GS15 | 1 | 1 | 1 | 1 | 1 | 1 | 1 | 1 | 1 | 1 | 1 | 1 | 0 | 1 | 1 | 1 |
| GS16 | 1 | 1 | 1 | 1 | 1 | 1 | 1 | 1 | 1 | 1 | 1 | 1 | 1 | 1 | 1 | 1 |

In said Table the sub-line times (pulses) are indicated as P1₀₀ or Pp_{xy}, where p is the phase number of the gray-table in Table 4, x refers to the first gray-table definition (as defined in Table 4) as used in the first superframe and y refers to the frame-number in the superframe. So, in short, the next superframe is defined, supposing a cyclical phase-sequence, by:

frame

| | | | |
|---|---|---|---|
| Frame 0 | Frame 1 | Frame 2 | Frame 3 |

pulse

| | | | | | | | | | | | | | | | |
|---|---|---|---|---|---|---|---|---|---|---|---|---|---|---|---|
| P1₀₀ | P2₀₀ | P3₀₀ | P0₀₀ | P2₀₁ | P3₀₁ | P0₀₁ | P1₀₁ | P3₀₂ | P0₀₂ | P1₀₂ | P2₀₂ | P0₀₃ | P1₀₃ | P2₀₃ | P3₀₃ |

And the next-following superframe is defined by:

frame

| | | | |
|---|---|---|---|
| Frame 0 | Frame 1 | Frame 2 | Frame 3 |

pulse

| | | | | | | | | | | | | | | | |
|---|---|---|---|---|---|---|---|---|---|---|---|---|---|---|---|
| P2₀₀ | P3₀₀ | P0₀₀ | P1₀₀ | P3₀₁ | P0₀₁ | P1₀₁ | P2₀₁ | P0₀₂ | P1₀₂ | P2₀₂ | P3₀₂ | P1₀₃ | P2₀₃ | P3₀₃ | P4₀₃ |

So, depending on the kind of driving (based on time periods or sub-line times (pulses) in frame periods) a grayscale-table is defined which is used in driving the display device.

When using a superframe consisting of 16 frames, each having 4 sub-line times, and driving 2 lines simultaneously, as in multiple row addressing, certain picture elements are for example allotted to columns and rows as in the matrix shown below.

TABLE 6

| | C_0 | C_1 | C_2 | C_3 | C_4 | C_5 | C_6 | C_7 | . . . | C_128 | C_129 | C_130 | C_131 |
|---|---|---|---|---|---|---|---|---|---|---|---|---|---|
| R_0 | 0 | 5 | 13 | 11 | 0 | 5 | 13 | 11 | . . . | 0 | 5 | 13 | 11 |
| R_1 | 4 | 10 | 2 | 7 | 4 | 10 | 2 | 7 | . . . | 4 | 10 | 2 | 7 |
| R_2 | 0 | 5 | 13 | 11 | 0 | 5 | 13 | 11 | . . . | 0 | 5 | 13 | 11 |
| R_3 | 4 | 10 | 2 | 7 | 4 | 10 | 2 | 7 | . . . | 4 | 10 | 2 | 7 |
| . | . | . | . | . | . | . | . | . | . | . | . | . | . |
| . | . | . | . | . | . | . | . | . | . | . | . | . | . |
| . | . | . | . | . | . | . | . | . | . | . | . | . | . |
| R_128 | 0 | 5 | 13 | 11 | 0 | 5 | 13 | 11 | . . . | 0 | 5 | 13 | 11 |
| R_129 | 4 | 10 | 2 | 7 | 4 | 10 | 2 | 7 | . . . | 4 | 10 | 2 | 7 |
| R_130 | 0 | 5 | 13 | 11 | 0 | 5 | 13 | 11 | . . . | 0 | 5 | 13 | 11 |
| R_131 | 4 | 10 | 2 | 7 | 4 | 10 | 2 | 7 | . . . | 4 | 10 | 2 | 7 |

Each picture element in the matrix (132 rows, 132 columns) has a particular phase (frame number, which is indicated per picture element) which corresponds to a particular frame by which the picture element is driven. The phases are repeated in blocks of 2 rows and 4 columns (2×4 mixing). The same frame drives each picture element in successive superframes, comparable to the driving shown in Table 2 (see Table 7).

TABLE 7
super frame

| frame 0 | | | | frame 1 | | | | . . . | frame 15 | | | |
|---|---|---|---|---|---|---|---|---|---|---|---|---|
| 0 | 5 | 13 | 11 | 0 | 5 | 13 | 11 | . . . | 0 | 5 | 13 | 11 |
| 4 | 10 | 2 | 7 | 4 | 10 | 2 | 7 | . . . | 4 | 10 | 2 | 7 |
| 0 | 5 | 13 | 11 | 0 | 5 | 13 | 11 | . . . | 0 | 5 | 13 | 11 |
| 4 | 10 | 2 | 7 | 4 | 10 | 2 | 7 | . . . | 4 | 10 | 2 | 7 |

According to the invention, in a similar way as described above, the particular phase (frame number) is now increased after each frame time, leading to the following driving scheme:

TABLE 8
super frame

| frame 0 | | | | frame 1 | | | | . . . | frame 15 | | | |
|---|---|---|---|---|---|---|---|---|---|---|---|---|
| 0 | 5 | 13 | 11 | 1 | 6 | 14 | 12 | . . . | 15 | 4 | 12 | 10 |
| 4 | 10 | 2 | 7 | 5 | 11 | 3 | 8 | . . . | 3 | 9 | 1 | 6 |
| 0 | 5 | 13 | 11 | 1 | 6 | 14 | 12 | . . . | 15 | 4 | 12 | 10 |
| 4 | 10 | 2 | 7 | 5 | 11 | 3 | 8 | . . . | 3 | 9 | 1 | 6 |

To display a block of (4×4) picture elements of the display, as shown in FIG. 3, having picture elements 8 in the upper half displayed in gray-level 7 (GS 7), while the lower part is displayed in gray-level 9 (GS 9).

Suppose GS 7 and GS 9 are defined according to Table 9. In said table Fp defines a frame (part) (which may be a frame as part of a superframe, like in Tables 2, 3 or a phase as part of a frame, like in Tables 4, 5).

TABLE 9

| | Frame (part) | | | | | | | | | | | | | | | |
|---|---|---|---|---|---|---|---|---|---|---|---|---|---|---|---|---|
| | Fp0 | Fp1 | Fp2 | Fp3 | Fp4 | Fp5 | Fp6 | Fp7 | Fp8 | Fp9 | Fp10 | Fp11 | Fp12 | Fp13 | Fp14 | Fp15 |
| GS7 | 1 | 0 | 1 | 0 | 1 | 0 | 1 | 0 | 1 | 0 | 1 | 0 | 1 | 0 | 1 | 0 |
| GS9 | 0 | 1 | 1 | 0 | 1 | 1 | 0 | 1 | 0 | 1 | 1 | 0 | 1 | 1 | 0 | 1 |

The ‘1’ represents an on frame (art), a zero corresponds to an off frame (part)

According to the phases given in Table 8 the picture elements are in the on (black) and off (white) state respectively as indicated in FIG. 4. For example, a picture element 8(1) displaying gray-level GS 7 is in the on state during phase 0 (Fp0₀₀) of frame 0 (frame (art) 0). More generally, the notation Fpx_{yy} is used in which x refers to the frame, while yy refers to the phase.

Other picture elements 8 (2, 3, 4) displaying gray-level GS 7 are driven during the other phases (5, 13, 11 or Fp0₀₅, Fp0₁₃, Fp0₁₁) of frame 0 (frame (part)s 5, 13, 11) in the off state. In a similar way picture elements 8 (5, 6, 7) displaying gray-level GS 7 are driven in the on state during phases 4, 10, 2 or Fp0₀₄, Fp0₁₀, Fp0₀₂ of frame 0 (frame (part) 0). The picture elements 8 (8) displaying gray-level GS 7 are driven in the off state by phase 7(Fp0₀₇) of frame 0 (frame (part) 7).

In a similar way, to obtain gray-level GS 9 picture elements 8 (10, 11, 13, 14, 15, 16) displaying gray-level GS 9 are driven in the on state during phases 5, 13, 4, 10, 2 and 7 or Fp0₀₅, Fp0₁₃, Fp0₀₄, Fp0₁₀, Fp0₀₂ and Fp0₀₇ of frame 0 (frame (part)s 5, 13, 4, 10, 2, 7) and picture elements 8 (9, 12) are driven in the off state by phases 0, 11 or Fp0₀₀, Fp0₁₁ of frame 0 (frame (part)s 0, 11).

In the next frame the phase-numbers (frame (part) numbers) are increased by one. Based on the on (black) and off (white) states respectively, as indicated in Table 9, the picture element 8(1) displaying gray-level GS 7 is in the off state during phase 0 (Fp1₀₀) of frame 1 (frame (part) 1). Other picture elements 8 (2, 3, 4) displaying gray-level GS 7 are driven in the on state during the other phases (6, 14, 12) or Fp1₀₆, Fp1₁₄, Fp1₁₂ of frame 1 (frame (part)s 6, 14, 12). In a similar way picture elements 8 (5, 6, 7) displaying gray-level GS 7 are driven in the off state during phases 5, 11, 3 or Fp1₀₅, Fp1₁₁, Fp1₁₃ of frame 1 (frame (part) 1). The picture elements 8 (8) displaying gray-level GS 7 are driven in the off state by phase 8 (Fp1₀₈) of frame 1 (frame (part) 8), see FIG. 4.

In a similar way, to obtain gray-level GS 9 picture elements 8 (10, 11, 14, 15, 16) displaying gray-level GS 9 are driven in the off state during phases 6, 14, 11, 3 and 8 or Fp1₀₆, FP1₁₄, Fp1₁₁, Fp1₀₃ and Fp1₀₈ of frame 1 (frame (part)s 6, 14, 11, 3, 8) and picture elements 8 (9, 12, 13) are driven in the on state by phases 1, 12 and 5 or Fp1₀₁, Fp1₁₂, Fp1₀₅ of frame 1 (frame (part)s 1, 12, 5), see FIG. 4.

By defining the grayscale (levels) according to Table 9, on and off frames are spread over the superframe as much as possible. As a result, the effective voltage (or root mean square Voltage Vᵣₘₛ) which the liquid crystal layer encounters is spread evenly over the superframe, thereby suppressing flicker and enabling low frame frequencies. Since adjacent picture elements having substantially the same gray levels are addressed out of phase, the invention enables lowering of the frame frequency. For picture elements addressed in phase (prior art), flicker is visible at a certain frequency, whereas at this same frame frequency flicker is not visible if picture elements are addressed out of phase.

Instead of using Table 5 for defining the gray-levels, other definitions may be used as well, e.g. the driving as shown in Table 5 may be used as gray-levels defined as initial gray-levels. Another possibility in which grayscale table sequences of s (s=4) sequential graylevels are defined by grouping s sequential graylevels within a sequence is shown below.

TABLE 10
frame

| | | | |
|---|---|---|---|
| Frame 0 | Frame 1 | Frame 2 | Frame 3 |

pulse

| | P0 | P1 | P2 | P3 | P0 | P1 | P2 | P3 | P0 | P1 | P2 | P3 | P0 | P1 | P2 | P3 |
|---|---|---|---|---|---|---|---|---|---|---|---|---|---|---|---|---|
| GS0 | 0 | 0 | 0 | 0 | 0 | 0 | 0 | 0 | 0 | 0 | 0 | 0 | 0 | 0 | 0 | 0 |
| GS1 | 1 | 0 | 0 | 0 | 0 | 0 | 0 | 0 | 0 | 0 | 0 | 0 | 0 | 0 | 0 | 0 |
| GS2 | 1 | 1 | 0 | 0 | 0 | 0 | 0 | 0 | 0 | 0 | 0 | 0 | 0 | 0 | 0 | 0 |
| GS3 | 1 | 1 | 1 | 0 | 0 | 0 | 0 | 0 | 0 | 0 | 0 | 0 | 0 | 0 | 0 | 0 |
| GS4 | 1 | 1 | 1 | 1 | 0 | 0 | 0 | 0 | 0 | 0 | 0 | 0 | 0 | 0 | 0 | 0 |
| GS5 | 1 | 1 | 1 | 1 | 0 | 0 | 0 | 0 | 1 | 0 | 0 | 0 | 0 | 0 | 0 | 0 |
| GS6 | 1 | 1 | 1 | 1 | 0 | 0 | 0 | 0 | 1 | 1 | 0 | 0 | 0 | 0 | 0 | 0 |
| GS7 | 1 | 1 | 1 | 1 | 0 | 0 | 0 | 0 | 1 | 1 | 1 | 0 | 0 | 0 | 0 | 0 |
| GS8 | 1 | 1 | 1 | 1 | 0 | 0 | 0 | 0 | 1 | 1 | 1 | 1 | 0 | 0 | 0 | 0 |
| GS9 | 1 | 1 | 1 | 1 | 1 | 0 | 0 | 0 | 1 | 1 | 1 | 1 | 0 | 0 | 0 | 0 |
| GS10 | 1 | 1 | 1 | 1 | 1 | 1 | 0 | 0 | 1 | 1 | 1 | 1 | 0 | 0 | 0 | 0 |
| GS11 | 1 | 1 | 1 | 1 | 1 | 1 | 1 | 0 | 1 | 1 | 1 | 1 | 0 | 0 | 0 | 0 |
| GS12 | 1 | 1 | 1 | 1 | 1 | 1 | 1 | 1 | 1 | 1 | 1 | 1 | 0 | 0 | 0 | 0 |
| GS13 | 1 | 1 | 1 | 1 | 1 | 1 | 1 | 1 | 1 | 1 | 1 | 1 | 1 | 0 | 0 | 0 |
| GS14 | 1 | 1 | 1 | 1 | 1 | 1 | 1 | 1 | 1 | 1 | 1 | 1 | 1 | 1 | 0 | 0 |
| GS15 | 1 | 1 | 1 | 1 | 1 | 1 | 1 | 1 | 1 | 1 | 1 | 1 | 1 | 1 | 1 | 0 |
| GS16 | 1 | 1 | 1 | 1 | 1 | 1 | 1 | 1 | 1 | 1 | 1 | 1 | 1 | 1 | 1 | 1 |

Some other possibilities are e.g.:

TABLE 11
frame

| | | | |
|---|---|---|---|
| Frame 0 | Frame 1 | Frame 2 | Frame 3 |

pulse

| | P0 | P1 | P2 | P3 | P0 | P1 | P2 | P3 | P0 | P1 | P2 | P3 | P0 | P1 | P2 | P3 |
|---|---|---|---|---|---|---|---|---|---|---|---|---|---|---|---|---|
| GS0 | 0 | 0 | 0 | 0 | 0 | 0 | 0 | 0 | 0 | 0 | 0 | 0 | 0 | 0 | 0 | 0 |
| GS1 | 0 | 0 | 0 | 0 | 0 | 0 | 0 | 0 | 0 | 0 | 0 | 0 | 1 | 0 | 0 | 0 |
| GS2 | 0 | 0 | 0 | 0 | 0 | 0 | 0 | 0 | 0 | 0 | 0 | 0 | 1 | 1 | 0 | 0 |
| GS3 | 0 | 0 | 0 | 0 | 0 | 0 | 0 | 0 | 0 | 0 | 0 | 0 | 1 | 1 | 1 | 0 |
| GS4 | 1 | 1 | 1 | 1 | 0 | 0 | 0 | 0 | 0 | 0 | 0 | 0 | 0 | 0 | 0 | 0 |
| GS5 | 1 | 1 | 1 | 1 | 0 | 0 | 0 | 0 | 0 | 0 | 0 | 0 | 1 | 0 | 0 | 0 |
| GS6 | 1 | 1 | 1 | 1 | 0 | 0 | 0 | 0 | 0 | 0 | 0 | 0 | 1 | 1 | 0 | 0 |
| GS7 | 1 | 1 | 1 | 1 | 0 | 0 | 0 | 0 | 0 | 0 | 0 | 0 | 1 | 1 | 1 | 0 |
| GS8 | 1 | 1 | 1 | 1 | 1 | 1 | 1 | 1 | 0 | 0 | 0 | 0 | 0 | 0 | 0 | 0 |
| GS9 | 1 | 1 | 1 | 1 | 1 | 1 | 1 | 1 | 0 | 0 | 0 | 0 | 1 | 0 | 0 | 0 |
| GS10 | 1 | 1 | 1 | 1 | 1 | 1 | 1 | 1 | 0 | 0 | 0 | 0 | 1 | 1 | 0 | 0 |
| GS11 | 1 | 1 | 1 | 1 | 1 | 1 | 1 | 1 | 0 | 0 | 0 | 0 | 1 | 1 | 1 | 0 |
| GS12 | 1 | 1 | 1 | 1 | 1 | 1 | 1 | 1 | 1 | 1 | 1 | 1 | 0 | 0 | 0 | 0 |
| GS13 | 1 | 1 | 1 | 1 | 1 | 1 | 1 | 1 | 1 | 1 | 1 | 1 | 1 | 0 | 0 | 0 |
| GS14 | 1 | 1 | 1 | 1 | 1 | 1 | 1 | 1 | 1 | 1 | 1 | 1 | 1 | 1 | 0 | 0 |
| GS15 | 1 | 1 | 1 | 1 | 1 | 1 | 1 | 1 | 1 | 1 | 1 | 1 | 1 | 1 | 1 | 0 |
| GS16 | 1 | 1 | 1 | 1 | 1 | 1 | 1 | 1 | 1 | 1 | 1 | 1 | 1 | 1 | 1 | 1 |

Or

TABLE 12
frame

| | | | |
|---|---|---|---|
| Frame 0 | Frame 1 | Frame 2 | Frame 3 |

pulse

| | P0 | P1 | P2 | P3 | P0 | P1 | P2 | P3 | P0 | P1 | P2 | P3 | P0 | P1 | P2 | P3 |
|---|---|---|---|---|---|---|---|---|---|---|---|---|---|---|---|---|
| GS0 | 0 | 0 | 0 | 0 | 0 | 0 | 0 | 0 | 0 | 0 | 0 | 0 | 0 | 0 | 0 | 0 |
| GS1 | 0 | 0 | 0 | 0 | 0 | 0 | 0 | 0 | 0 | 0 | 0 | 0 | 1 | 0 | 0 | 0 |
| GS2 | 0 | 0 | 0 | 0 | 0 | 0 | 0 | 0 | 0 | 0 | 0 | 0 | 1 | 1 | 0 | 0 |
| GS3 | 0 | 0 | 0 | 0 | 0 | 0 | 0 | 0 | 0 | 0 | 0 | 0 | 1 | 1 | 1 | 0 |
| GS4 | 0 | 0 | 0 | 0 | 1 | 1 | 1 | 1 | 0 | 0 | 0 | 0 | 0 | 0 | 0 | 0 |
| GS5 | 0 | 0 | 0 | 0 | 1 | 1 | 1 | 1 | 0 | 0 | 0 | 0 | 1 | 0 | 0 | 0 |
| GS6 | 0 | 0 | 0 | 0 | 1 | 1 | 1 | 1 | 0 | 0 | 0 | 0 | 1 | 1 | 0 | 0 |
| GS7 | 0 | 0 | 0 | 0 | 1 | 1 | 1 | 1 | 0 | 0 | 0 | 0 | 1 | 1 | 1 | 0 |
| GS8 | 1 | 1 | 1 | 1 | 0 | 0 | 0 | 0 | 1 | 1 | 1 | 1 | 0 | 0 | 0 | 0 |
| GS9 | 1 | 1 | 1 | 1 | 0 | 0 | 0 | 0 | 1 | 1 | 1 | 1 | 1 | 0 | 0 | 0 |
| GS10 | 1 | 1 | 1 | 1 | 0 | 0 | 0 | 0 | 1 | 1 | 1 | 1 | 1 | 1 | 0 | 0 |
| GS11 | 1 | 1 | 1 | 1 | 0 | 0 | 0 | 0 | 1 | 1 | 1 | 1 | 1 | 1 | 1 | 0 |
| GS12 | 1 | 1 | 1 | 1 | 1 | 1 | 1 | 1 | 1 | 1 | 1 | 1 | 0 | 0 | 0 | 0 |
| GS13 | 1 | 1 | 1 | 1 | 1 | 1 | 1 | 1 | 1 | 1 | 1 | 1 | 1 | 0 | 0 | 0 |
| GS14 | 1 | 1 | 1 | 1 | 1 | 1 | 1 | 1 | 1 | 1 | 1 | 1 | 1 | 1 | 0 | 0 |
| GS15 | 1 | 1 | 1 | 1 | 1 | 1 | 1 | 1 | 1 | 1 | 1 | 1 | 1 | 1 | 1 | 0 |
| GS16 | 1 | 1 | 1 | 1 | 1 | 1 | 1 | 1 | 1 | 1 | 1 | 1 | 1 | 1 | 1 | 1 |

FIG. 5 shows a display device in which multiple row addressing is applied as described in an article by T. J. Scheffer and B. Clifton “Active Addressing Method for High-Contrast Video Rate STN Displays”, SID Digest 92, pp. 228-231, which describes how the phenomenon of “frame response” which occurs with rapidly switching liquid crystal materials is avoided by making use of “Active Addressing”. In this method, all rows are driven throughout the frame period with mutually orthogonal signals, for example, Walsh functions. The result is that each picture element is continuously excited by pulses (in an STN LCD of 240 rows: 256 times per frame period) instead of once per frame period. In “multiple row addressing”, a (sub-) group of p rows is driven with mutually orthogonal signals. Since a set of orthogonal signals, such as Walsh functions, consists of a plurality of functions which is a power of 2, i.e. 2^{S}, p is preferably chosen to be equal thereto as much as possible, i.e. generally p=2^{S} (or also p=2^{S}−1). The orthogonal row signals Fᵢ(t) are preferably square-wave shaped and consist of voltages +F and −F, while the row voltage is equal to zero outside the selection period. The elementary voltage pulses from which the orthogonal signals are built up are regularly distributed across the frame period. In this way, the picture elements are then excited 2^{S} (or (2^{S}−1)) times per frame period with regular intermissions instead of once per frame period. Even for low values of p such as p=3 (or 4) or p=7 (or 8) the frame response appears to be suppressed just as satisfactorily as when all rows are driven simultaneously, such as in “Active Addressing”, but it requires much less electronic hardware.

The display device of FIG. 5 comprises again a matrix 11 of picture elements at the area of crossings of m rows 12 and n columns 13 which are provided as row and column electrodes on facing surfaces of substrates 14, 15, as can be seen in the cross-section shown in the matrix 11. The liquid crystal material 16 is present between the substrates. Other elements such as orientation layers, polarizers, etc. are omitted in the cross-section for the sake of simplicity.

The device further comprises a row function generator 17 in the form of, for example, a ROM for generating orthogonal signals Fᵢ(t) for driving the rows 12. Similarly, as described in said article by Scheffer and Clifton, row vectors driving a group of p rows via drive circuits 4 are defined during each elementary time interval. The row vectors are written into a row function register 19.

Information 10 to be displayed is stored in an n×m buffer memory 11 which contains a look-up table 20, for example derived as discussed above with respect to FIG. 3 (combination of the Tables 8, 9) and read as information vectors per elementary unit of time. Signals for the column electrodes 6 are obtained by multiplying the then valid values of the row vector and the information vector during each elementary unit of time and by subsequently adding the obtained products. The multiplication of the values of the row and column vectors which are valid during an elementary unit of time is realized by comparing them in an array 22 of m exclusive ORs. The addition of the products is effected by applying the outputs of the array of exclusive ORs to the summing logic 13. The signals 21 from the summing logic 13 drive a column drive circuit 5 which provides the columns 3 with voltages Gⱼ(t) having p+1 possible voltage levels. Every time, p rows are driven simultaneously, in where p<N (“multiple row addressing”). As well as the information vectors, the row vectors therefore only have p elements, which results in a saving of the required hardware such as the number of exclusive ORs and the size of the summing circuit, as compared to the method in which all rows are driven simultaneously with mutually orthogonal signals (“Active Addressing”).

The drive electronics is minimized by choosing p to be low, for example, in the range between 3 and 8. FIG. 6 shows schematically how the display device is driven with a set of orthogonal functions referred to as Fᵢ(t) and the pulse patterns derived therefrom for the purpose of multiple row addressing with p=4 for a first frame.

As a possible example it is shown how gray levels can be displayed using this set of orthogonal functions according to the grayscale definition of Table 10.

The orthogonal functions or row selection pulses are indicated schematically. The general formula calculating the column signals G(t) for p rows addressed simultaneously is given by:

$${G}_{i} ( t ) = C {\sum }_{i = 1}^{p} {d}_{ij} {F}_{i} ( t )$$

where Fᵢ(t) represents the orthogonal function applied to rowᵢ and dᵢⱼ represents the picture element data of rowᵢ and columnⱼ.

For the above example we have:
G₁(t)=C{d₁₁F₁(t)+d₂₁F₂(t)+d₃₁F₃(t)+d₄₁F₄(t)}
According to Table 10, GS 6 is defined as having all 4 sub-line times in the on state for frame 0, i.e. d₁₁ is −1 for 4 sub-line times (=one line time). For GS 3 the picture element is in the on state for the first 3 sub-line times, and the 4^{th} sub-line time the picture element is in the off state, i.e. d₂₁ is −1 for the first 3 sub-line times and +1 for the 4^{th} line time. For GS 11 the picture element is in the on state for all four sub-line times, while for GS 0 the picture element is in the off state for all four sub-line times.

Function F₁(t) is −1 for the first line time (i.e. 4 sub-line times), +1 for the 2^{nd}, 3^{rd} and 4^{th} line time. Function F₂(t) is −1 for the second line time (i.e. 4 sub-line times), +1 for the first, 3^{rd} and 4^{th} line time, etcetera.

Substituting this for the first 4 line times of frame 0, the column signal G₁(t) for column 1 as shown in FIG. 7 is found.

The invention is of course not limited to the embodiments shown. The logic in the driver IC can make multiple selections from the programmed orthogonal matrices during frames and also after whole frames. Also vectors within an orthogonal matrix can be swapped or inverted by the driver to reduce the number of column signal transitions. Furthermore it is possible to let the driver IC decide which orthogonal matrix it will use for certain display data content. In this way an adaptive multiple orthogonal matrix multiple row addressing drive is created which results in a low display current and module power independent of the data to be displayed.

As mentioned in the introduction the invention is also applicable the principle of the invention can also be applied to Active matrix LCDs by using time averaging between two gray-values, e.g. averaging over 4 (or 8 or even 16) phases (frames) to reduce the number of generated voltages via the resistor chain.

Table 13 indicates possible combinations of the standard gray-value generation technique with that of phase-mixing (frame rate control, FRC). The total number of gray-values is equal for all cases, i.e. 8 bit. Of course combinations like “4 bit standard” and “2 bit FRC” are attractive in case of 6 bit color gray-values. Instead of a using a resistor chain other ways of generating (fixed) gray-values may be used

TABLE 13

| Total of | Number of | | Number of | | |
|---|---|---|---|---|---|
| bits for | bits for (fixed) | Number | bits for gray- | Number | |
| gray- | gray-values | of output | values via | of | |
| values | via e.g. chain | buffers | mixing | frames | |
| 8 bit | 1 bit | 2 | 7 bit | 128 | |
| 8 bit | 2 bit | 4 | 6 bit | 64 | |
| 8 bit | 3 bit | 8 | 5 bit | 32 | |
| 8 bit | 4 bit | 16 | 4 bit | 16 | mixing |
| 8 bit | 5 bit | 32 | 3 bit | 8 | mixing |
| 8 bit | 6 bit | 64 | 2 bit | 4 | mixing |
| 8 bit | 7 bit | 128 | 1 bit | 2 | mixing |
| 8 bit | 8 bit | 256 | — | 1 | Standard |

According to the table above, if 64 gray-values (for each of three color) are generated in a standard way and frame rate control is used to extend the number of gray-values to 256 (per color) 4 frames are needed to do so. The table below shows how 3 gray-values in between gray-values 18 and 19 are generated. The resulting gray-value is the average of the 4 frames.

TABLE 14

| Frame 1 | Frame 2 | Frame 3 | Frame 4 | Resulting GS |
|---|---|---|---|---|
| 18 | 18 | 18 | 18 | 18 |
| 18 | 18 | 18 | 19 | 18.25 |
| 18 | 19 | 18 | 19 | 18.50 |
| 18 | 19 | 19 | 19 | 18.75 |
| 19 | 19 | 19 | 19 | 19 |

This can be done for intermediate values between two gray-value GS out of the grayscale of 64 gray-values and as a result 256 gray-values (per color) are obtained which is comparable to using 8 bits in the standard way. The advantage is that only 64 buffers are needed in the output stage instead of 256 for the standard way of gray-scale generation. Hence, the source output stage is reduced with 25%, which will result in a significant driver cost reduction.

As the switching times are relatively fast for AMLCD displays, flicker can be observed due to the slightly different display contents in each of the four frames. Most sensitive to flicker are patterns in which the total display area is displayed in one particular gray-value e.g. 18.25 from above example.

To avoid flickering artifacts, phase mixing is applied in a similar way as described above for passive displays. To this end, in one example the display area is divided into a number of sections. These sections display the contents of different frames, i.e. one section displays frame 1, another sections displays frame 3 etc. In the next frame, these sections display frame 2 and 4 respectively. After 4 frames, each section has displayed all 4 frame contents so that the perceived gray-value is equal for all sections. The smaller the sections the less sensitive is the human eye for flicker artifacts. As an example, Tables 15 and 16 show the generation of gray-value 18.25 for the total display area in time.

TABLE 15

| | | | |
|---|---|---|---|
| Frame 1 | Frame 2 | Frame 3 | Frame 4 |

| | | | | | | | |
|---|---|---|---|---|---|---|---|
| F1 | F4 | F2 | F1 | F3 | F2 | F4 | F3 |
| F3 | F2 | F4 | F3 | F1 | F4 | F2 | F1 |
| F1 | F4 | F2 | F1 | F3 | F2 | F4 | F3 |
| F3 | F2 | F4 | F3 | F1 | F4 | F2 | F1 |

The display is e.g. divided into 8 sections. In these sections the phase (frame number) is indicated. For a specific gray value, the definition table (of Table 14 in this case)) shows which content to display at each phase (frame) number. After each phase (frame), the phase (frame) number is increased by one. In this example, the entire display area will show gray-value 18.25 as defined in table 15.

TABLE 16

| Superframe | | | | | | | |
|---|---|---|---|---|---|---|---|
| Frame 1 | | Frame 2 | | Frame 3 | | Frame 4 | |
| 18 | 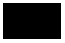 | 18 | 18 | 18 | 18 | 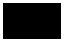 | 18 |
| 18 | 18 | 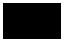 | 18 | 18 | 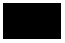 | 18 | 18 |
| 18 | 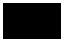 | 18 | 18 | 18 | 18 | 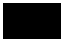 | 18 |
| 18 | 18 | 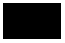 | 18 | 18 | 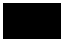 | 18 | 18 |

The sections are in different phases (different frame numbers). This phase shift makes the flicker artifact less visible for the human eye. As a consequence, the frame frequency at which the flickering becomes visible is reduced due to the frame mixing. As a result, the power consumption is reduced further.

It will be clear that other combinations of numbers of output buffers and number of bits for gray-values via mixing (as shown in Table 13) can be used as well. While phase-mixing with 16 phases the scheme of FIG. 9 can be used, while in the example of phase-mixing with 4 phases the schemes of FIGS. 10-12 can be alternatively used.

The protective scope of the invention is not limited to the embodiments described. The invention resides in each and every novel characteristic feature and each and every combination of characteristic features. Reference numerals in the claims do not limit their protective scope. The use of the verb “to comprise” and its conjugations does not exclude the presence of elements other than those stated in the claims. The use of the article “a” or “an” preceding an element does not exclude the presence of a plurality of such elements.

1. A display device comprising a liquid crystal between a first substrate provided with selection electrodes and data electrodes and a second substrate in which picture electrodes at picture elements are present and switching means for connecting the picture electrodes to the selection electrodes and data electrodes and drive means for driving the picture elements in confirmity with an image to be displayed, and drive means for driving the selection electrodes which, in the operation condition, within a sequence of m (m>1) time periods, during each time period sequentially selection electrodes during a selection time with selection signals for driving picture elements, the drive means comprising means for driving a group of picture elements during time periods within a sequence of time periods, the driving of different picture elements within a sequence of time periods being phase-shifted with respect to each other.

2. A display device comprising a liquid crystal between a first substrate provided with row or selection electrodes and a second substrate provided with column or data electrodes, in which overlapping parts of row and column electrodes define picture elements, drive means for driving the column electrodes in conformity with an image to be displayed, and drive means for driving the row electrodes which, in the operating condition, within a sequence of m (m>1) time periods, during each time period sequentially supply groups of p (p≧1) row electrodes during a selection time with mutually orthogonal selection signals for driving picture elements, the drive means comprising means for driving a group of picture elements during time periods within a sequence of time periods, the driving of different picture elements within a sequence of time periods being phase-shifted with respect to each other.

3. A display device as claimed in claim 1, in which the phase numbers of the time periods are increased or decreased by one after each sequence of time periods.

4. A display device as claimed in claim 1, comprising a grayscale table for generating graylevel data in which grayscale table sequences of s sequential graylevels are defined by grouping s sequential graylevels within a sequence, said sequences being allotted to non-sequential selections of time periods within a sequence of time periods.

5. A display device as claimed in claim 4, in which a sequence of selections is allotted to increasing gray values or decreasing gray values.

6. A display device as claimed in claim 5, in which increases (or decreases) of the number of selections within a sequence of selections is allotted to one time period only.

7. A display device as claimed in claim 1, in which a sequence of time periods is a sequence of frame periods.

8. A display device as claimed in claim 5, comprising means to change the frame-phase of a frame during selection of said frame in subsequent sequences of frame periods.

9. A display device as claimed in claim 1, comprising means to apply during sub-selection times of a selection time different voltages to the column electrodes.

10. A display device as claimed in claim 1, comprising means to change the sub-selection time-phase during selection of a sub-selection time in subsequent sequences of selection times.

11. A display device as claimed in claim 1, the phase shifting being altered after each sequence of time periods.

12. A display device as claimed in claim 6, in which p=1, the drive means for driving the column electrodes having means for providing different voltages to the column or data electrodes at sub-selection times of the selection times.

13. A display device as claimed in claim 1, in which p=4.
